(19) United States
(12) Patent Application Publication
(10) Pub. No.: US 2008/0204007 A1
(43) Pub. Date: Aug. 28, 2008

(54) Rotation detecting sensor

(75) Inventors: Kyungwoo Kim, Tsu-city (JP); Takaki Iwashita, Tsu-city (JP); Tadashi Hattori, Tsu-city (JP)

Correspondence Address: MCDERMOTT WILL & EMERY LLP, 600 13TH STREET, N.W., WASHINGTON, DC, 20005-3096, US

(73) Assignee: SUMIDEN ELECTRONICS, LTD.

(21) Appl. No.: 12/071,739

(22) Filed: Feb. 26, 2008

(30) Foreign Application Priority Data
Feb. 26, 2007 (JP) 2007-045402

(51) Int. Cl. G01B 7/30; B29C 45/00

(52) U.S. Cl. 324/207.25; 264/328.1

(57) ABSTRACT

A wheel speed sensor includes a hall IC that outputs a signal representing a change of magnetic field generated by rotation of a detection object and that is simply covered with resin coating. In the process of molding the resin coating, a resin injection opening is positioned away from an end face of a sheath of a cable to be coated by a length no less than a minimum adhesion length for ensuring adhesion between the sheath and the resin coating. In addition, the holder and a cover of the detector are provided with waterproof protrusions extending along the entire peripheries of contact areas in which pressing pins are brought into contact with the holder and the cover. Accordingly, immersion of the detector is reliably prevented even when a void or the like occurs in the resin coating at a position near the injection opening.

### BACKGROUND OF THE INVENTION

1. Field of the Invention

The present invention relates to rotation detecting sensors, such as a wheel speed sensor and an engine speed sensor of an automobile.

2. Description of the Background Art

FIGS. 8A and 8B show a wheel speed sensor P as an example of a rotation detecting sensor. The wheel speed sensor P includes a detector a composed of, for example, a magnetoelectric conversion element, such as a hall element and a magnetoresistive (MR) element. The detector a is disposed so as to face a rotating body (detection object) B that rotates in association with a wheel. The detector a detects a change of magnetic field caused by rotation of the rotating body B, converts the change of magnetic field into an electric signal, and outputs the electric signal to a cable 6.

An example of this type of wheel speed sensor P is disclosed in Japanese Unexamined Patent Application Publication No. 2006-30075 (see FIGS. 1 and 2). In this wheel speed sensor P, the detector a is attached to (provided on) a resin holder (bobbin). The holder is inserted into an operculated tubular casing through an opening formed therein, and thus the detector a is mounted in the casing. A pair of lead pieces extending from the detector a is connected to a pair of trunk terminals. The trunk terminals extend out of the holder through an end face of a base portion of the holder, and are connected to the cable 6. The opening in the casing and the entire periphery of the exposed portion of the holder are covered with resin while the trunk terminals and a part of the cable 6 are embedded in the resin.

Another example of the wheel speed sensor P is disclosed in Japanese Unexamined Patent Application Publication No. 2005-227095 (see FIG. 1). In this wheel speed sensor P, as shown in FIGS. 8A and 8B, the detector a is directly covered with resin coating 4 without being mounted in a casing. In addition, the lead pieces are directly connected to the output cable 6 without interposing trunk terminals therebetween. Referring to FIGS. 8A and 8B, the wheel speed sensor P is attached to the vehicle body with an attachment 10.

This type of wheel speed sensor P is generally installed in an Anti-Lock Brake System (ABS) or the like, and is therefore required to have high durability. In addition, the wheel speed sensor P is generally disposed around a wheel of a vehicle, and is exposed not only to rain water but also to water splashed from the road. Therefore, the wheel speed sensor P is also required to have high waterproof property.

Accordingly, in the process of forming the resin coating 4, a harness sealing component homogeneous with a sheath of the cable 6 is insert-molded at the boundary between the resin coating 4 and the cable 6 inserted and embedded therein. The harness sealing component prevents immersion of water through the boundary between the cable 6 and the resin coating 4. An example of such a structure is described in Japanese Unexamined Patent Application Publication No. 2006-78222 (see FIG. 1).

In the wheel speed sensor P shown in FIGS. 8A and 8B in which the detector a is simply covered with the resin coating 4 to reduce cost, if further cost reduction is required, it becomes necessary to reduce the number of components by omitting the harness sealing component (by adopting a non-sealing structure) or to reduce the layer thickness of the resin coating 4.

### SUMMARY OF THE INVENTION

An object of the present invention is to provide a new waterproof structure for a detector a in a rotation detecting sensor, such as the wheel speed sensor P shown in FIGS. 8A and 8B, in which the detector a is simply covered with the resin coating 4.

To achieve the above-described object, according to an aspect of the present invention, injection molding of the resin coating is performed such that an immersion (water arrival) length along the boundary of the resin coating from a region where the resin coating has a small thickness or where no resin coating is applied is increased. A portion of the resin coating having a small thickness may have a defect such as a pinhole, and there is a risk of immersion due to such a defect. In addition, immersion, of course, occurs in regions where no resin coating is applied. Because the immersion length along the boundary of the resin coating from the region where immersion is likely to occur is increased, the risk of immersion is reduced.

More specifically, a holder and a cover of the detector a are provided with waterproof protrusions extending along the entire peripheries of contact areas in which pressing pins are brought into contact with the holder and the cover in the process of injection molding of the resin coating.

In the process of injection molding of the resin coating, the detector a is fixed by pressing pins to prevent the detector a from moving because the movement of the detector a leads to, for example, reduction in the detection accuracy. Portions at which the detector a is fixed by the pressing pins are, of course, not coated with the resin. Accordingly, the waterproof protrusions are provided so as to extend along the entire peripheries of the contact areas of the pressing pins. As a result, water must pass through the protrusions to cause immersion, and the immersion length along the boundary of the resin is increased to the length corresponding to the sum of the length of the surfaces of the protrusions and the length of the side surface of the resin coating. Therefore, the risk of immersion can be reduced. The contact areas of the pressing pins may also have a waterproof material applied thereto or be filled with the waterproof material.

With regard to the structure of the above-described aspect of the present invention, a rotation detecting sensor includes a detector including a magnetoelectric conversion element that detects a change of magnetic field generated by rotation of a detection object, converts the change of magnetic field into an electric signal, and outputs the electric signal, and lead terminals extending from the magnetoelectric conversion element; a holder to which the detector is attached; a cable connected to the lead terminals to transmit the electric signal to the outside; and resin coating that covers the detector and a portion of the cable. The holder and a cover of the detector are provided with waterproof protrusions extending along the entire peripheries of contact areas in which pressing pins are brought into contact with the holder and the cover in the process of injection molding of the resin coating.

In addition, to achieve the above-described object, according to another aspect of the present invention, a resin injection opening through which resin is injected for forming the resin coating is positioned outside a waterproof sealing section, such as waterproof protrusions (i.e., closer to the outer side of the resin coating than the waterproof sealing section with respect to the detector).

In the process of molding the resin coating, there is a risk that pressure keeping (injection pressure) of a molding device is switched off (reduced) before the resin near the resin injection opening (gate) solidifies and stops flowing. In such a case, the resin in the molten state flows backwards through the injection opening and warpage, sink, or a void (hollow space) may occur in the resin near the injection opening. If a void or the like occurs, the thickness of the resin coating around the void is reduced and adhesion between the resin and the cable and between the resin and the holder is degraded. Therefore, sufficient water-tightness (air tightness) cannot be obtained.

Even when a void or the like occurs, immersion can be prevented if the resin injection opening through which resin is injected for forming the resin coating is outside the waterproof sealing section. More specifically, even when the water-tightness of the resin coating in a region between the resin injection opening and the waterproof sealing section is reduced due to the occurrence of the void or the like, a portion of the resin coating extending between the waterproof sealing section and the detector to be protected from immersion has sufficient water-tightness at the boundary between the resin coating and the cable and between the resin coating and the holder. Thus, immersion can be prevented.

The waterproof sealing section may have various structures, such as the above-described waterproof protrusions. For example, the waterproof sealing section may be an adhesion section of a sheath of the cable and the resin coating and extending from an end face of the sheath of the cable by a minimum adhesion length L for ensuring adhesion between the sheath and the resin coating in the length direction of the sheath.

The minimum adhesion length L is set such that the wheel speed sensor provides sufficient performances according to the Japan Automobile Standard Organization (JASO) C467-97 “7.8 sealing test”. For example, as shown in FIG. 9, the wheel speed sensor P is immersed in water in a water tank S, and a resistance between the water in the water tank S and core wires 6a of the cable is detected. The minimum adhesion length L is set such that the resistance is 100 MΩ or more and such that the output of the wheel speed sensor P after the test is within a standard range.

With regard to the structure of the second aspect of the present invention, a rotation detecting sensor includes a detector including a magnetoelectric conversion element that detects a change of magnetic field generated by rotation of a detection object, converts the change of magnetic field into an electric signal, and outputs the electric signal, and lead terminals extending from the magnetoelectric conversion element; a holder to which the detector is attached; a cable connected to the lead terminals to transmit the electric signal to the outside; and resin coating that covers the detector and a portion of the cable. A resin injection opening through which resin is injected to form the resin coating is positioned outside a waterproof sealing section for the detector.

The waterproof sealing section is obtained by setting the minimum adhesion length L or by forming a waterproof protrusion extending along the entire periphery of a portion of the holder at a predetermined position.

In the case in which the waterproof sealing section is obtained by setting the minimum adhesion length L, the resin injection opening through which resin is injected for forming the resin coating is positioned away from the end face of the sheath by a distance equal to or larger than the minimum adhesion length L (see FIG. 6).

In the case in which the waterproof protrusion is formed as the waterproof sealing section, the waterproof protrusion is formed as to extend along the entire periphery of a portion of the holder in front of the detector. In addition, the resin injection opening is positioned in front of the protrusion (see FIG. 7).

In the above-described structures, the holder and the cover of the detector may be provided with waterproof protrusions extending along the entire peripheries of contact areas in which pressing pins are brought into contact with the holder and the cover in the process of injection molding of the resin coating.

According to the present invention, a new waterproof structure of a detector is provided in a rotation detecting sensor in which the detector is simply covered with resin coating. Therefore, the detector can be easily sealed and the overall size can be reduced by reducing the thickness of the resin coating.

### BRIEF DESCRIPTION OF THE DRAWINGS

FIG. 1 is a sectional front view according to a first embodiment of the present invention.

FIG. 2 is an exploded perspective view of components including a detector according to the embodiment.

FIG. 3 is a perspective view of a structure including the detector.

FIG. 4 is a perspective view of the structure including the detector viewed from the bottom in FIG. 3.

FIG. 5A is a relevant part sectional view illustrating a contact area of a retaining member (cover) in which a pressing pin comes into contact with the retaining member in the process of forming resin coating.

FIG. 5B is a relevant part sectional view illustrating a contact area of a front (left) portion of a holder shown in FIG. 4 in which a pressing pin comes into contact with the holder in the process of forming the resin coating.

FIG. 5C is a relevant part sectional view illustrating a contact area of a rear (right) portion of the holder shown in FIG. 4 in which a pressing pin comes into contact with the holder in the process of forming the resin coating.

FIG. 6 is a sectional view illustrating a process by which the structure of the embodiment is manufactured.

FIG. 7 is a sectional view illustrating a process by which the structure of another embodiment is manufactured.

FIG. 8A is an outline view of mounting aspect showing the left side of a wheel speed sensor.

FIG. 8B is an outline view of mounting aspect showing the front of the wheel speed sensor.

FIG. 9 is a diagram illustrating the sealing test of the wheel speed sensor.

### DESCRIPTION OF THE PREFERRED EMBODIMENTS

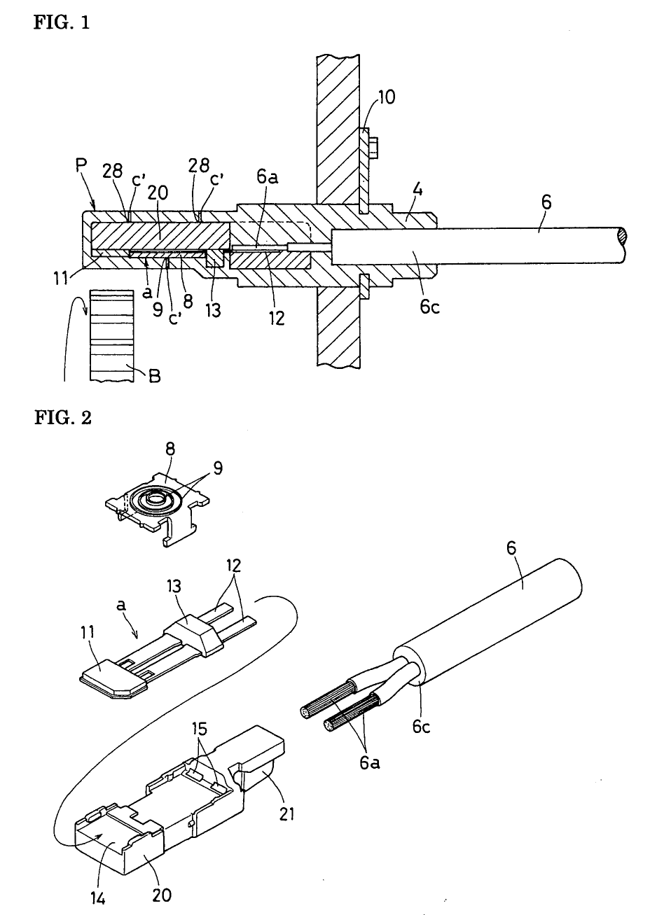

FIGS. 1 to 4 illustrate an embodiment of the present invention. In this embodiment, a wheel speed sensor P includes a detector a. The detector a includes a hall IC 11 having a hall element (rotation detecting element) that detects a change of magnetic field, a pair of linear lead pieces (lead terminals) 12 extending parallel to each other from the hall IC 11, and an electronic component 13, such as a capacitor, disposed between the lead pieces 12 and 12. The lead pieces 12 and 12 are connected to respective flexible core wires (conductors) 6a and 6a, which are electric insulated wires included in an output cable 6 by soldering or the like (see FIGS. 2 to 4). The electronic component 13 can be omitted as necessary.

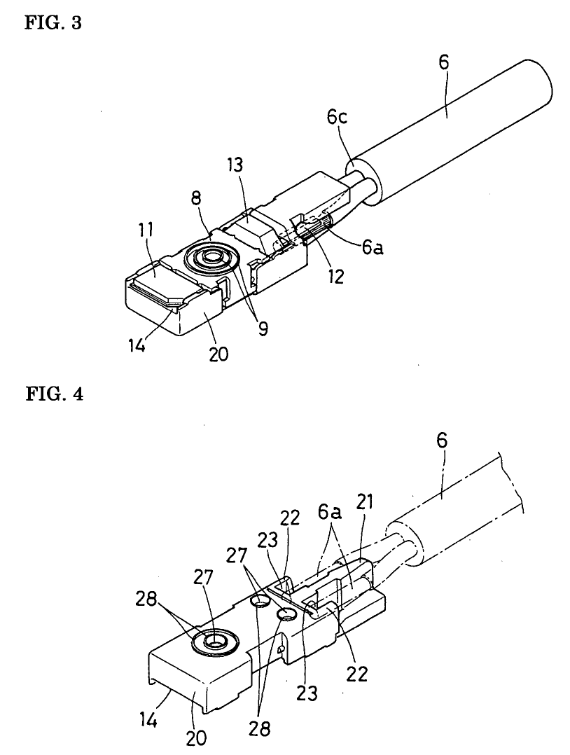

A holder 20 is formed by resin molding. As shown in FIGS. 2 and 3, the holder 20 has a rectangular solid shape and a fitting concave portion 14 for receiving the hall IC 11 is provided on one side of the holder 20 in a front region thereof. In addition, insertion holes 15 for receiving the respective lead pieces 12 are formed in a rear wall of the holder 20 (see FIG. 2). The lead pieces 12 are inserted into the respective insertion holes 15, and the hall IC 11 is fitted into the concave portion 14. Thus, the detector a is reliably set in (held by) the holder 20 at a predetermined position.

Positioning holes 27 for receiving pressing pins in the process of molding resin coating 4, which will be described below, is formed in a rear surface (top surface in FIG. 4) of the holder 20. The number and positions of the holes 27 are determined taking into account the support stability of the holder 20 in the process of resin coating (molding).

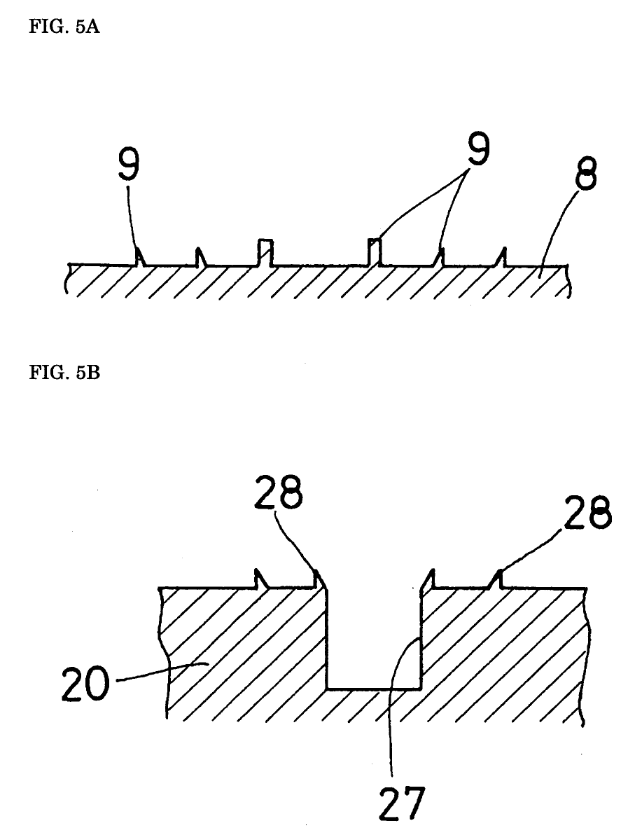

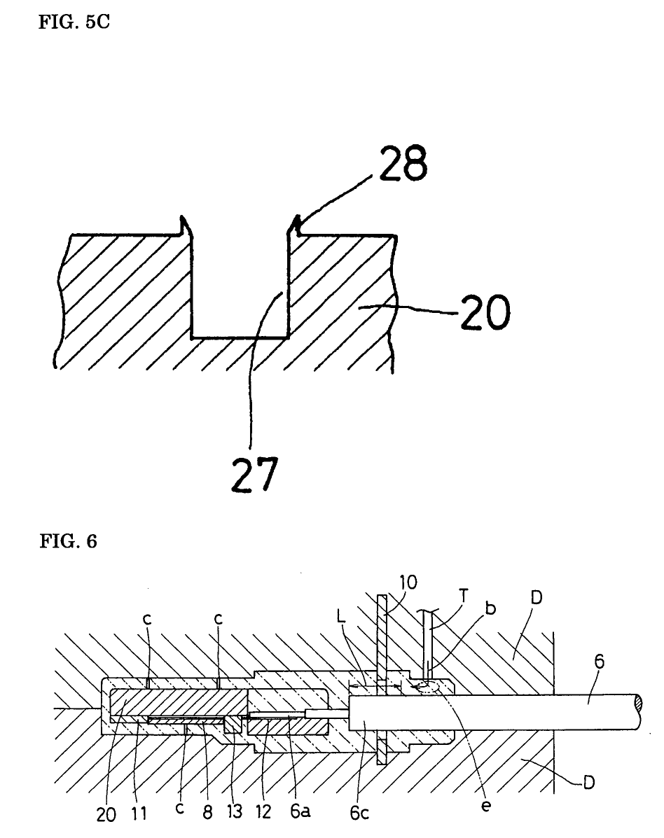

Waterproof protrusions 28 having a sectional triangular shape are formed so as to extend along the entire peripheries of the positioning holes 27 (see FIGS. 5B and 5C). The size, sectional shape, number, intervals, etc. of the protrusions 28 are determined taking into account the waterproof performance, which will be described below.

Referring to the figures, a retaining member (cover) 8 is fitted to the holder 20 after the detector a is set to the holder 20. The detector a is reliably held by the holder 20 by fitting the retaining member 8 to the holder 20.

The retaining member 8 also has waterproof protrusions 9 similar to the waterproof protrusions 28 on a surface thereof. The waterproof protrusions 9 extend along the entire periphery of a region at which a pressing pin is brought into contact with the retaining member 8 in the process of molding the resin coating 4 (see FIGS. 2, 3, and 5A). The size, sectional shape, number, intervals, etc. of the protrusions 9 are also determined taking into account the waterproof performance.

The holder 20 has a separation wall 21 at a position between contact portions of the lead pieces 12 and the respective flexible core wires 6a of the output cable 6 (see FIG. 4). The separation wall 21 serves to prevent the core wires 6a and 6a from coming into contact with each other. In addition, side walls 22 for preventing the flexible core wires 6a from being displaced outward are disposed outside the respective connecting portions. The side walls 22 define pocket areas 23 (spaces surrounded by the separation wall 21 and the side walls 22). In the process of connecting the core wires 6a and 6a of the output cable 6 with the respective lead pieces 12 and 12, first, the core wires 6a and 6a exposed at an end of the output cable 6 are inserted into the pocket areas 23. Then, the core wires 6a and 6a are set so as to extend along the separation wall 21 with the separation wall 21 placed therebetween. At this time, the flexible core wires 6a are preferably twisted to prevent them from loosening.

The flexible core wires 6a are connected to the lead pieces 12 of the detector a attached to the holder 20 by soldering. After the flexible core wires 6a are connected to the respective lead pieces 12, as shown in FIG. 6, the holder 20 to which the detector a is attached and the output cable 6 are placed in a cavity of a mold D. Then, pressing pins c are pressed against the bottom surface of the holder 20 and the surface of the retaining member 8 (inserted into the holes 27) so as to position the holder 20.

In this state, molten resin b is injected into the cavity of the mold through a resin injection opening T. Thus, the resin coating 4 in which the entire bodies of the hall IC 11, the lead pieces 12, and the holder 20 and parts of the output cable 6 and the attachment 10 are embedded is formed and the wheel speed sensor P is obtained. The attachment 10 can also be formed of the resin coating 4 (see FIG. 1 of Japanese Unexamined Patent Application Publication No. 2005-227095).

In the process of injection molding, the resin injection opening T is positioned away from the end face of a sheath 6c of the output cable 6 to be resin coated by a distance equal to or more than a minimum adhesion length L for ensuring the adhesion between the sheath 6c and the resin coating 4 along the length of the sheath 6c.

Thus, the resin injection opening T is positioned away from the end face of the sheath 6c by a distance equal to or more than the minimum adhesion length L. In the process of resin coating (molding), there is a risk that pressure keeping (injection pressure) of a molding devices is switched off before the resin b near the injection opening T solidifies and stops flowing. In such a case, the resin b in the molten state flows backwards through the injection opening T and warpage, sink, or a void e may occur in the resin near the injection opening T (see the region surrounded by the two-dot chain line and denoted by e in FIG. 6). Even in such a case, since the resin coating 4 that continues from the detector a extends along the sheath 6c by a distance longer than the minimum adhesion length L sufficient to prevent immersion of the detector a. Accordingly, the water-tightness is ensured and the detector a is prevented from being immersed.

The resin coating 4 has holes c′ formed by the pressing pins c (see FIG. 1). However, water that enters the holes c′ is prevented from reaching the detector a by the protrusions 9 and 28. The protrusions 9 and 28 may be formed such that the protrusions 9 and 28 are partially fused into the resin coating 4 by reducing the thickness at the edges of the protrusions 9 and 28 (vertex of the sectional triangular shape, end of sectional rectangular shape, etc.) or reducing the overall thickness of the protrusions 9 and 28. In such a case, the waterproof performance can be further improved. This effect can be further enhanced by forming the resin coating 4 and the holder 20 (retaining member 8) using materials with high affinity, for example, homogeneous resins, so that they can easily fuse into each other. The holes c′ (including the holes 27) formed by the pressing pins c can also be filled with waterproof material.

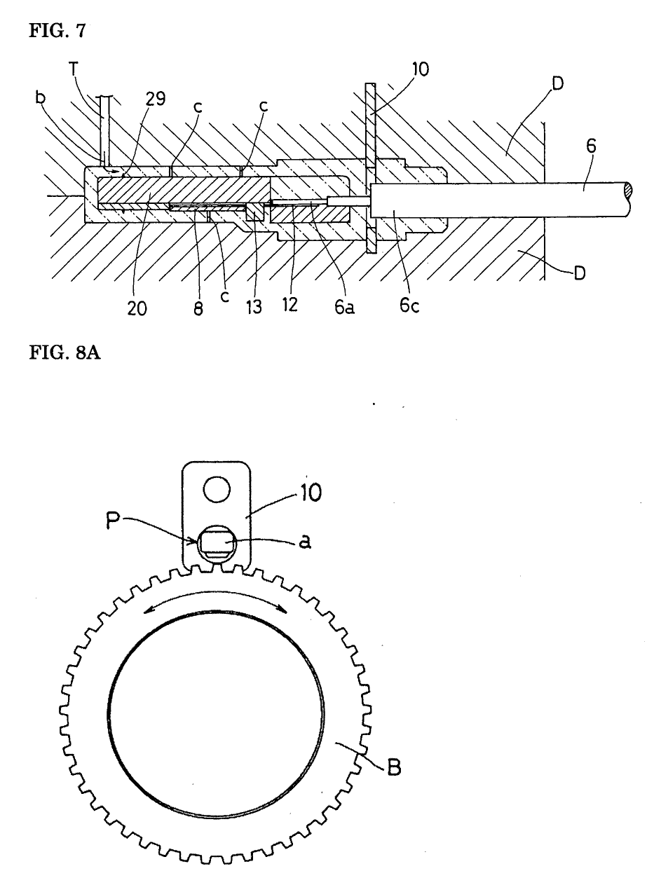

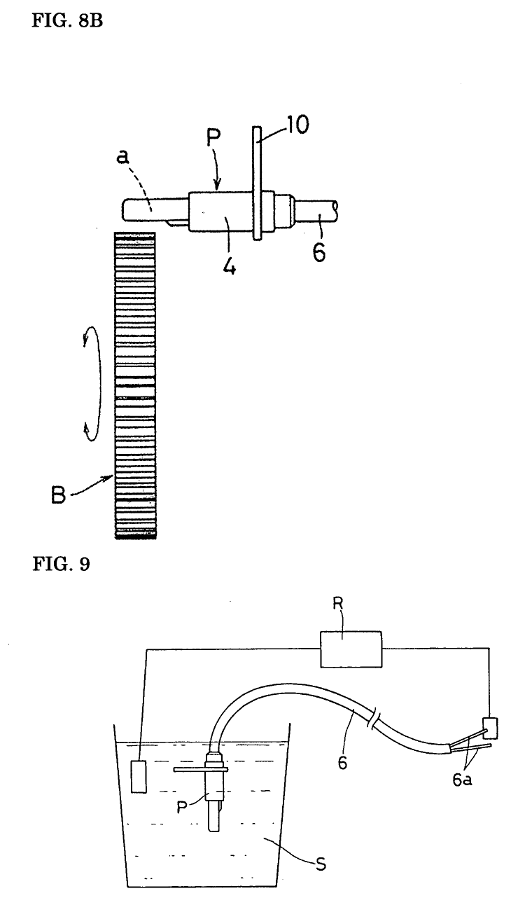

In the above-described embodiment, a waterproof sealing section for the detector a is obtained by setting the minimum adhesion length L for ensuring the adhesion between the sheath 6c of the cable 6 and the resin coating 4. However, the structure of the waterproof sealing section is not limited as long as the effects thereof can be obtained. For example, as shown in FIG. 7, the waterproof sealing section may also include a waterproof protrusion 29 formed so as to extend along the entire periphery of the holder 20 at a position in front of the detector a. In such a case, as shown in FIG. 7, the resin injection opening T is positioned in front of the protrusion 29. The size, sectional shape, number, intervals (along the length of the cable), etc. of the protrusion 29 are determined taking into account the waterproof performance.

The protrusions 29, 9, and 28 are formed irrespective of the position of the resin injection opening T. For example, the protrusion 29 may also be formed in the structure according to the embodiment shown in FIG. 1.

Although the wheel speed sensor P is described in the above-described embodiments, the present invention can, of course, also be applied to other types of rotation detecting sensors.

The above-disclosed embodiments are provided for illustrative purposes only and do not limit the present invention. The scope of the present invention is not limited by the above descriptions but is indicated by the following claims and includes equivalents of the claims and all modifications within the scope.

What is claimed is:

1. A rotation detecting sensor comprising:
a detector including a magnetoelectric conversion element that detects a change of magnetic field generated by rotation of a detection object, converts the change of magnetic field into an electric signal, and outputs the electric signal, and lead terminals extending from the magnetoelectric conversion element;
a holder to which the detector is attached;
a cable connected to the lead terminals to transmit the electric signal to the outside; and
a resin coating that covers the detector and a portion of the cable,
wherein the holder and a cover of the detector are provided with waterproof protrusions extending along the entire peripheries of contact areas in which pressing pins are brought into contact with the holder and the cover in the process of injection molding of the resin coating.

2. A rotation detecting sensor comprising:
a detector including a magnetoelectric conversion element that detects a change of magnetic field generated by rotation of a detection object, converts the change of magnetic field into an electric signal, and outputs the electric signal, and lead terminals extending from the magnetoelectric conversion element;
a holder to which the detector is attached;
a cable connected to the lead terminals to transmit the electric signal to the outside; and
a resin coating that covers the detector and a portion of the cable,
wherein a resin injection opening through which resin is injected in the process of injection molding of the resin coating is positioned outside a waterproof sealing section for the detector.

3. The rotation detecting sensor according to claim 2, wherein the resin injection opening is positioned away from an end face of a sheath of the cable to be coated with resin by a length equal to or larger than a minimum adhesion length for ensuring adhesion between the sheath and the resin coating in the length direction of the sheath, and
wherein the waterproof sealing section includes portions of the sheath and the resin coating adhered to each other over the minimum adhesion length.

4. The rotation detecting sensor according to claim 2, wherein the holder has a waterproof protrusion extending along the entire periphery of the holder at a position in front of the detector, and
wherein the resin injection opening is positioned in front of the protrusion.

5. The rotation detecting sensor according to claim 2, wherein the holder and a cover of the detector are provided with waterproof protrusions extending along the entire peripheries of contact areas in which pressing pins are brought into contact with the holder and the cover in the process of injection molding of the resin coating.

6. The rotation detecting sensor according to claim 3, wherein the holder and a cover of the detector are provided with waterproof protrusions extending along the entire peripheries of contact areas in which pressing pins are brought into contact with the holder and the cover in the process of injection molding of the resin coating.

7. The rotation detecting sensor according to claim 4, wherein the holder and a cover of the detector are provided with waterproof protrusions extending along the entire peripheries of contact areas in which pressing pins are brought into contact with the holder and the cover in the process of injection molding of the resin coating.

8. A method for manufacturing a rotation detecting sensor including a detector including a magnetoelectric conversion element that detects a change of magnetic field generated by rotation of a detection object, converts the change of magnetic field into an electric signal, and outputs the electric signal, and lead terminals extending from the magnetoelectric conversion element; a holder to which the detector is attached; a cable connected to the lead terminals to transmit the electric signal to the outside; and a resin coating that covers the detector and a portion of the cable,
wherein resin is injected at a position outside a waterproof sealing section for the detector in the process of injection molding of the resin coating.
